(19) United States
(12) Patent Application Publication
(10) Pub. No.: US 2025/0173900 A1
(43) Pub. Date: May 29, 2025

(54) METHOD FOR DETERMINING EXTRINSIC CAMERA PARAMETERS OF A CAMERA, EVALUATION MODULE, CAMERA AS WELL AS COMPUTER PROGRAM

(71) Applicant: Robert Bosch GmbH, Stuttgart (DE)

(72) Inventor: Moritz Michael Knorr, Hildesheim (DE)

(21) Appl. No.: 18/959,535

(22) Filed: Nov. 25, 2024

(30) Foreign Application Priority Data
Nov. 28, 2023 (DE) 10 2023 211 846.7

(51) Int. Cl. G06T 7/80; G06T 7/269

(52) U.S. Cl. CPC G06T 7/80; G06T 7/269; G06T 2207/30196; G06T 2207/30232; G06T 2207/30244

(57) ABSTRACT

The invention relates to a method for determining extrinsic camera parameters of a camera 1, wherein foot strike points 11 a, b of at least one object 8 walking on a monitoring base area 2 are determined based on image data of the camera 1, wherein the foot strike points 11 a, b comprise at least three step sections 12 a, b, wherein each step section 12 a, b is defined by two foot strike points 11 a, b, wherein the step sections 12 a, b each have a section length on the monitoring base area 2, wherein a pitch angle 3 and/or a roll angle 4 of the camera 1 relative to the monitoring base area 2 is determined based on the location of the step sections 12 a, b as well as a ratio of the section lengths on the monitoring base area 2 and/or based on the absolute section lengths on the monitoring base area 2.

### BACKGROUND

The invention relates to a method for determining extrinsic camera parameters of a camera. The invention also relates to an evaluation module for implementing the method, a camera with the evaluation module and a corresponding computer program.

To be able to obtain spatial information from a camera, it is advantageous to know the position and orientation of the camera relative to the environment. A specific, spatial structure represents the ground level/base plane or general ground surface. If this is known, the spacing and arrangement of objects can be easily determined.

Publication DE 10 2007 001 649 A1, which constitutes the closest prior art, discloses a method of calibrating a monitoring camera, which displays a real monitoring scene, which can be written in global coordinates, on a monitoring screen, which can be written in global coordinates, wherein at least one trajectory of a moving object in the monitoring scene is determined, which comprises a set of position data, describing the position of the moved object in image coordinates in a time-dependent manner, and wherein the trajectory is used to calibrate the monitoring camera, by converting the time-dependent location data of the moved object to distances in the real monitoring scene using a movement model of the moving object. The movement model is in particular configured as a pedestrian movement model.

### SUMMARY

One object of the invention is a method for determining extrinsic camera parameters of a camera. The camera may in particular be a monitoring camera. The camera is preferably configured as a permanently installed and/or stationary camera, in particular a monitoring camera, having a lens with a fixed focal length. Alternatively, it is also possible to use a movable/or zoom-enabled monitoring camera wherein, however, the extrinsic camera parameters are determined for all or a plurality of position and/or zoom settings or for a single position and/or zoom setting and are recalculated as a function of the camera setting. The camera can be in any configuration, i.e. a black/white or color camera, can have any lens, i.e. in particular wide-angle, fish-eye, tele- or 360° lens, and/or can be designed for any wavelength, i.e. UV, VIS, NIR or FIR. For example, the camera could be configured as a camera on vehicles, robots, or in the augmented reality area.

Extrinsic camera parameters are understood in particular to mean the external orientation of the camera. In particular, the extrinsic camera parameters are understood to mean a pitch angle and/or a roll angle of the camera. Optionally, the extrinsic camera parameters include the height of the camera over a monitoring base area.

Foot strike points of at least one object walking on the monitoring base area are determined based on image data from the camera. The image data is in particular configured as a video sequence of the camera. The camera thus captures a monitoring scene, wherein the at least one object is walking in the monitoring scene. The object is particularly preferably configured as a (human) person. Alternatively or in addition, the object can also be configured as a walking animal. Based on the image data, the foot strike points of the at least one object on the monitoring base area are determined from the image data. Thus, the positions in the image data at which the foot of the at least one object comes into contact with the monitoring base area are searched for either digitally or via a computer-supported process. In particular, the foot strike points are determined in image coordinates of the image data and/or the camera. A trajectory of the object can be formed using the foot strike points in the image data and/or in image coordinates, wherein the trajectory comprises the foot strike points as support points.

The foot strike points form at least three step sections, wherein each step section is defined by two foot strike points.

In particular, the step sections are straight connecting lines between two foot strike points. The step sections each have a section length on the monitoring base area and thus in real coordinates, in particular in global coordinates.

It is envisioned that that on the basis of the location of the step sections as well as, optionally, a ratio of the section lengths on the monitoring base area and thus in particular in real coordinates, in particular global coordinates, and/or based on the absolute section lengths on the monitoring base area, in real coordinates, in particular global coordinates, a pitch angle and/or a roll angle will be determined as extrinsic camera parameters of the camera relative to the monitoring base area and thus in real coordinates, in particular in global coordinates. The pivotal movement about a transverse axis of the camera, perpendicular to the camera's axis of view, and parallel or in alignment with the monitoring base area, is preferably referred to as pitching/the pitch angle. The pivotal movement about the camera's axis of view is preferably referred to as the roll angle.

An aspect of the invention is thus to use the foot strike points of a walking object for extrinsic calibration of the camera. It therefore takes advantage of the fact that the step length of an object is unchanged over several steps or, for example, can be easily estimated.

By using three step sections, wherein at least one relative information (ratio of section lengths) or absolute information (absolute section length of both step sections) is used, the location of the monitoring base area relative to the camera is unambiguously defined and can therefore be calculated or at least estimated. Therefore, it is firstly possible for the pitch and/or roll angle to be calculated analytically. Alternatively, it is possible for the calculation to be carried out via an iteration method. The orientation of the camera is determined, for example, by minimizing a cost function. The cost function thereby penalizes the deviation of the distances between the foot strike points, which are determined by projection of the corresponding image coordinates on the assumed base plane. Further alternatives can also be created via appropriately trained and applied AIs.

Particularly preferably, the pitch and/or roll angle are determined from three, in particular successive steps, preferably single steps, particularly preferably with four foot strike points of the object. It is assumed that the foot strike points are not exactly along a single line, which is typically not the case.

In a preferred embodiment of the invention, the precisely or at least three step sections each define a straight line section on the monitoring base area, wherein the straight line sections intersect. Because the straight line sections intersect, it is ensured that the straight line sections are linearly independent and contain sufficient information to determine the roll and/or pitch angles.

In a preferred realization of the invention, the three step sections have a common foot strike point and/or are associated with a common object. This variant is particularly accurate because the object is likely to use the same absolute section length for each step section.

In an alternative of the invention, the step sections are not connected and/or associated with the same object or different objects. In this alternative, for example, one of the step sections is formed by a first object and further step sections by a second object or even by a second and a third object. As long as one knows or can estimate at least the ratio of the section lengths and/or the absolute section lengths, the pitch angle and/or the roll angle can also be determined in this constellation.

Alternatively, it may be contemplated that the step sections are associated with different trajectories of the same object and/or spaced trajectory sections of the same object. Thus, it is possible for an object to pass through the recording area of the camera for a first time, wherein a first step section is captured, and subsequently or at a later time passing through the monitoring area a second time, wherein a second step section is captured and subsequently or at a later time passing through the monitoring area a third time, wherein a third step section is captured. Alternatively, or in addition, spaced trajectory sections may be used as step sections in a trajectory of an object. These latter possibilities have the advantage that the section length is respectively dependent on the step size of the same object and that it must be assumed at least as relative information that the section lengths of the step sections are the same length.

In a preferred and particularly simple configuration, the step sections each form a single step of the object. The section length of the step section thus corresponds to the spacing of the successive step placement points of a left foot and a right foot when the object is walking.

Alternatively, the step sections each form a double step of the object. This alternative thus provides that the section length is used by the spacing of the successive step placement points of only a right foot or only a left foot. This alternative has the advantage that, for example, an unequal gate, such as a limp, wherein the step length is dependent on whether the decelerating foot or the non-limping foot is being placed forward, can be eliminated, since only the distance from a single foot to itself is always monitored.

In a preferred further development of the invention, it is provided that a height of the camera relative to the monitoring base area is determined based on at least one absolute section length. In that at least one absolute section length is known as the standard, the extrinsic camera parameters, in particular the height of the camera above the monitoring base area, can not only be indicated a relative, but also in an absolute and/or in a dimensioned manner.

In a preferred realization of the invention, the section length, in particular the section length of a single step of the object or a double step (or even multiple steps) of the object, is assumed to be constant. Because of this, the method is particularly easy to implement.

In contrast, in an alternative or further development of the invention it is taken into account that the walking speed of the object can change and thereby also the absolute section lengths. It is therefore contemplated that the absolute section lengths will be estimated as a function of the time to traverse the step section.

In a possible embodiment of the invention, the foot strike point is determined by digital image processing, in particular via the analysis of the optical flow in the image data. It is contemplated that at the moment that the foot of the object occupies the foot strike point on the monitoring base area, the optical flow of pixels of the foot of the object is less than or equal to zero, as opposed to other pixels of the object, since the foot is stationary on the monitoring base area. In this way, the foot strike point can be determined easily and reliably. Alternatively, the foot strike point may also be determined by machine learning and/or AI methods.

The method described assumes that the same physical point can be determined on a foot or both feet of the object while they are in contact with the monitoring base area. Generally, what point on the foot this is not critical. It could be either the toe or the heel or any other point. In addition, it is not necessary that the point be found on both feet. The method also works if, for example, only the foot strike point for the left foot is found. Deep learning-based methods for determining foot strike points are known and are part of the prior art. In these, it must be determined when the foot is on the ground. This can be done, for example, based on the movement. An alternative approach to determining foot strike points on the ground could be based on optical flow. The fact that the foot on the ground is the only limb of a moving object that comes to a standstill could be utilized.

A further subject matter of the invention is an evaluation module for determining extrinsic camera parameters of one or the camera, wherein the evaluation module comprises an interface for connecting via data technology to a data source for receiving image data from the camera, wherein the evaluation module is configured to implement the method as previously described. In particular, it can be provided that the interface is directly connected to the camera as a source; alternatively, the image data is initially stored, e.g., in a database and the interface is connected to the database via data technology. The evaluation module can be configured as a digital data processing device and can be integrated in the camera, for example. Alternatively, the evaluation module is arranged decentrally to the camera. It is also possible that the evaluation module is configured as a software module and is implemented on a server or in the cloud.

A further subject matter of the invention relates to a camera as previously described, wherein the camera comprises the evaluation module, as previously described.

A further subject matter of the invention is a computer program which is configured to perform all steps of the method described above when using and/or executing the computer program on a computing unit and/or the evaluation module.

A further, optional subject matter of the invention is a machine-readable storage medium, wherein the computer program is stored on the machine-readable storage medium as described above.

First, some advantages and advantageous properties of the method are described in the following section. Then, possible variants and extensions will be described.

Advantages of the method are that few model assumptions are made regarding the walking behavior that can be applied to almost any monitoring scene that includes such objects, such as persons/the object does not have to move in a straight line, in particular, and different objects can have different step lengths. The detection of the foot strike points is relatively simple, since only the same point on the foot, but not necessarily, e.g., the heel or ball of the foot must be detected. The method can also potentially be extended to several planes or to general (but not completely arbitrary) ground surfaces. Even a few, in particular successive steps (three) are sufficient to determine a solution, which makes the method more robust. The properties can be easily combined with further information, such as the upright axis of the object for calibration. The average step length (or in combination, also average object size) may be used to determine the height of the camera above the ground.

One possible extension of the method is to model a change in step length as section length. The step length could change in a linear manner over time, for example. Thus, only one further parameter would have to be co-determined. Two options would be, for example: 1) The change follows a simple model, such as a linear change, so the step length gets shorter by a fixed value at each step. If this were recognized or known, such an assumption could be introduced directly, since the characteristic of the same step length is not mathematically decisive in finding the solution as long as the ratios are known.

2) Most likely, people change their step sequences and lengths as they transition from walking to standing in a similar manner that can be statistically modelled, and that could be adopted as a model here.

An alternative to this is to segment trajectories with foot strike points into respective short step sequences (e.g. three steps, i.e. 4 foot strike points) and assume a consistent step length within each of these step sequences. This has the advantage that a solution can already be determined from each of these step sequences and then only the consensus between the solutions has to be found. In this way, however, several solutions can also be found more easily, for example due to several non-parallel planes as monitoring base areas. It may also be advantageous to treat the left and right foot strike points, respectively, as two point series/trajectories. The assumed step length would be the same for both series in this case. However, for example, an unequal spacing between directly sequential step lengths, e.g. caused by hobbling, could be dealt with without errors. After all, the method is not necessarily limited to humans but could also be used for animals.

### BRIEF DESCRIPTION OF THE DRAWINGS

Further features, effects and advantages of the invention are shown in the following description of a preferred exemplary embodiment of the invention and in the accompanying figures. Shown are:

FIG. 1 a schematic representation of a structure for implementing a method for determining extrinsic camera parameters of a camera;

FIG. 2 a schematic top view of the monitoring base area of the structure in FIG. 1 with the trajectory depicted;

FIG. 3 in the same representation as in FIG. 2, a schematic top view of the monitoring base area with alternative trajectories;

FIG. 4 in the same representation as in FIG. 2, a schematic top view of the monitoring base area with alternative trajectories.

### DETAILED DESCRIPTION

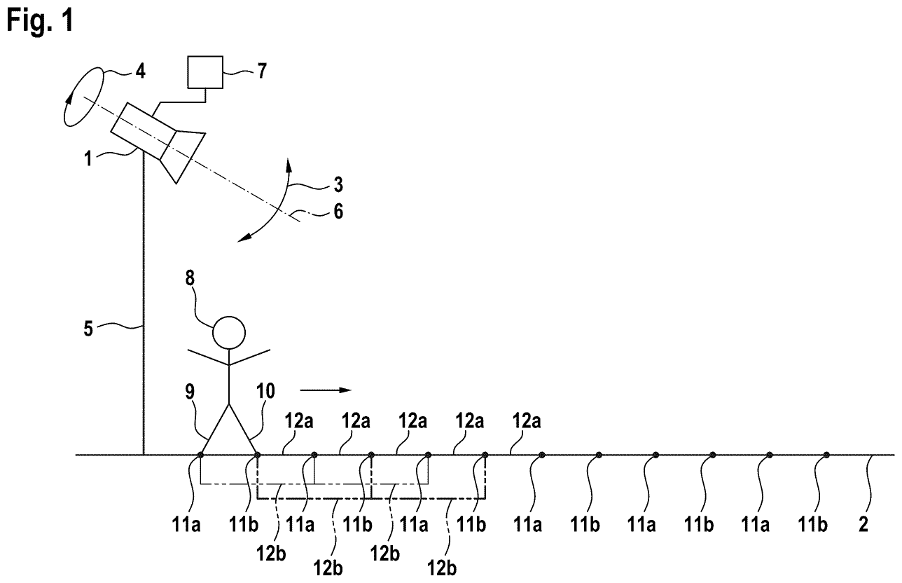

FIG. 1 shows a highly schematic representation of a structure for implementing a method for determining extrinsic camera parameters of a camera 1. The camera 1 is directed toward a monitoring area, wherein at least one monitoring base area 2 is arranged in the monitoring area. The position of the camera 1 relative to the monitoring base area 2 is determined via extrinsic camera parameters, namely or in particular a pitch angle 3, a roll angle 4 and/or a height 5. The pivot axis to the pitch angle 3 is arranged perpendicular to the optical axis 6 of the camera 1 and/or in alignment with the monitoring base area 2. The pivot axis to the roll angle 4 is arranged coaxially to the optical axis 6. The height 5 is determined as in particular the perpendicular distance of the camera 1 to the monitoring base area 2.

The camera 1 is connected to an evaluation module 7 and/or the evaluation module 7 is arranged in the camera 1. The evaluation device 7 may be designed as a digital data processing device, such as a computer. However, it may also be implemented as a software module in a cloud or on a server.

In the monitoring area, and in particular on the monitoring base area 2, a person is arranged as object 8, and is walking on the monitoring base area 2. The person as object 8 has two feet 9, 10, wherein 2 foot strike points 11 a, b are formed by walking on the monitoring base area. The foot strike points 11 a are associated with the left foot 9 of the object 8, the foot strike points 11 b are associated with the right foot 10 of the object 8.

In order to be able to derive spatial information from the camera 1, it is advantageous to know the position and orientation relative to the environment. A specific spatial structure represents the ground level/base surface or general ground surface as the monitoring base area 2. If this is known, the distances and arrangements of objects may easily be determined. A method is described here that determines the orientation of a camera 1 with respect to the monitoring base area 2. In this method, people are used as objects 8 (pedestrians) that pass through the scene in question. More specifically, the step lengths of the persons are used as the basis for the objects 8. It is assumed that the step length does not change in the short term and changes in walking behavior (acceleration, deceleration) are detected. The advantage of this method is that it can be used in a very wide variety of ways and does not require any other knowledge of the scene. Knowledge of the actual step length is not required.

It is thus assumed that the foot strike point series (also called the point series or trajectory 13) of a moving person as an object 8 will be used for extrinsic calibration of the camera 1. Thereby, the fact that the step length of the person as an object 8 is unchanged over several steps (or can be described, for example, by a simple model), is utilized. Assuming that there is only one dominant plane in the scene as monitoring base area 2, this extrinsic calibration can be described using three parameters (pitch angle 3, roll angle 4 and height 5 above ground/monitoring base area 2). The two angles 3, 4 can be determined using the method described herein. The height 5 can be derived, for example, via further assumptions, such as average step lengths as absolute section length.

The determination of the roll and pitch angles 3, 4 for the example in FIG. 1 is described here. The foot strike points 11 a, b of the person as object 8 (or multiple persons) are initially annotated in a video sequence as image data using a method (or manually). These can then be used directly to determine the orientation (corresponding to roll and pitch angles 3, 4). For this purpose, it was assumed that the step lengths remain constant as section lengths over time. In general, it is possible to determine the two orientation angles 3, 4 from even just three successive or offset steps (four foot strike points 11 a, b) of a person as object 8. It is assumed that the foot strike points 11 a, b are not exactly along the same line, which is typically not the case. If an upright axis of the person as object 8 is added as optional additional information, the orientation can even be determined to 0.7 degrees in this example. Assuming that the base surface has no slope, the person's upright axis represents a direct mapping of the normal vector of the base plane. An angular component can thus be directly observed from it.

In this exemplary embodiment, the intrinsic parameters (lens distortion and focal length) are known. Assuming an average step length, the height 5 of the camera 1 can in this case even be determined to 5-10 percent. The orientation (pitch angle 3, roll angle 4) of the camera 1 is determined here by minimizing a cost function. The cost function penalizes the deviation of the distances of the foot strike points 11 a, b, which are determined by projection of the corresponding image coordinates on the assumed monitoring base area 2. The upright axis and consistency of the height of a person as object 8 may be treated similarly as an optional addition.

To determine the extrinsic camera parameters, step sections 12 a or 12 b are formed, wherein the step sections 12 a are formed as individual steps and the step sections 12 b are defined as double steps.

In the single steps as the section length of the step section 11 a, the distance between the successive foot strike points 11 a, b of the left foot 9 and right foot 10 is used. In the double steps, the distance between the successive foot strike points 11 a of the left foot 9 or the foot strike points 11 b of the right foot 10 are used as the section length of the step sections 12 b.

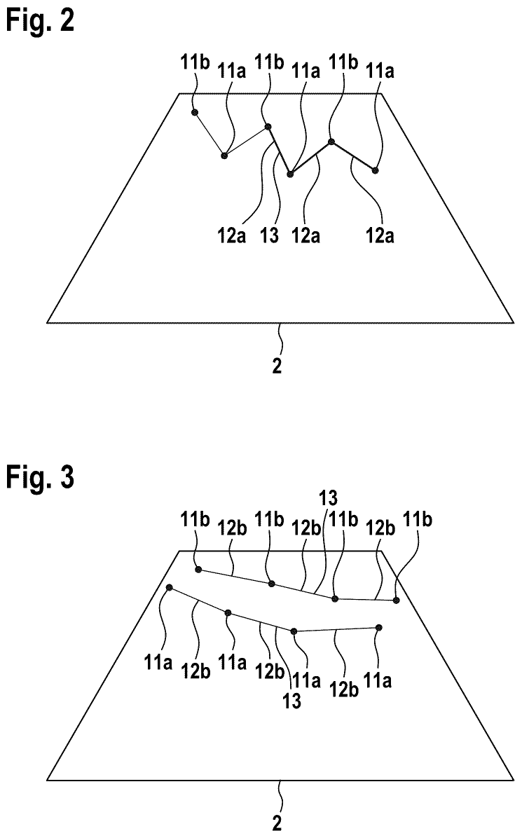

FIG. 2 shows, in a schematic top view of the monitoring base area 2, the trajectory 13 formed from the foot strike points 11 a, b approximately from the camera perspective of the camera 1.

To determine the extrinsic camera parameters, at least three successive step sections 12 a are selected, wherein at least a ratio of the section lengths on the monitoring base area 2 or absolute values for the absolute section lengths on the monitoring base area 2 for the selected step sections 12 a are known or are or can be estimated. With respect to the ratio of the section lengths, it can be assumed that this does not change with a trajectory 13 and/or a person as object 8, so that “1” can simply be selected as the ratio.

For example, as shown, the section length of the step sections 12 a, which are connected to one another via a common foot strike point 11 a and 11 b, is known to be the same length.

The pitch angle 3 and the roll angle 4 are varied via an iterative method until the resulting values for the section lengths reflect the smallest deviation of the foot strike points 11 a, b calculated therefrom on the monitoring base area 2 in comparison to the foot strike points 11 a, b captured via the image data of the camera 1. The pitch angle 3 and the roll angle 4 can thus be determined by the iterative procedure. In the exemplary embodiment in FIG. 2, the step sections 12a are contiguous.

FIG. 3 shows a variant of FIG. 2, wherein the step sections 12b are formed either by the foot strike points 11 a of the left foot 9 of the person as object 8 or by the foot strike points 11 b of the right foot 10 of the person as object 8. The section lengths between them are thus configured as double steps. The evaluation of the resulting trajectories 13 is carried out analogously to FIG. 2: Starting from three step sections 12 a or (exclusively or) 12 b, the iterative method is used to vary the pitch angle 3 and roll angle 4 until the resulting values for the section lengths are formed for the smallest deviation of the foot strike points 11 a and 11 b calculated therefrom on the monitoring base area 2 in comparison to the foot strike points 11 a and 11 b captured via the image data of the camera 1. The pitch angle 3 and the roll angle 4 can thus be determined by the iterative procedure. In the exemplary embodiment in FIG. 3, the step sections 12a on the one hand and the step sections 12 b on the other hand are contiguous.

It should be emphasized that the step sections 12 a and 12 b used for the determination should not lie on a common straight line, because the determination could thus be made more difficult or even impossible. Rather, defined straight line sections should intersect through step sections 12a and 12b, respectively.

The determination may be carried out in various embodiments—so it is contemplated that any selection of step sections 12 a and/or 12 b will be employed for determination, provided at least one ratio of the associated section lengths is known. Alternatively, it is also possible to use spaced trajectory sections of the trajectory 13, provided at least a ratio of the associated section lengths is known.

In the event that an absolute section length is known, it can be used as a standard, such that e.g. the height 5 can be determined in absolute values/length dimensions (e.g. in meters).

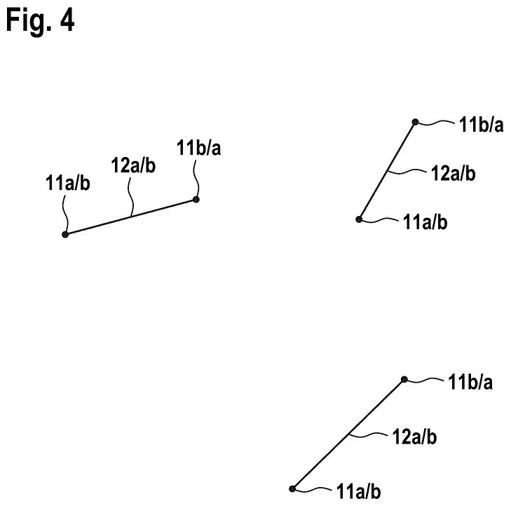

FIG. 4 shows a further exemplary embodiment, wherein three step sections 12a or 12b are shown as a result of foot strike points 11a, b. In this most general exemplary embodiment,
any selection of step sections 12 a or 12 b can be used.
the step sections 12a or 12b can be connected or not connected.
the step sections 12 a and 12 b, respectively, can come from one or more objects 8.
the step sections can be connected or not connected.

However, the step sections 12 a and 12 b may not be along a common line. Preferably, the step sections 12 a or b define straight lines that are linearly independent of each other. The ratios of the step section lengths or the absolute values of the step sections 12 a or b must be optionally known or able to be estimated. In the event that at least one absolute value of the step section lengths 12 a or b is known, the height 5 can be determined. In the event that only the ratios are known, the angles 3, 4 can be determined. Optionally, the height 5 can be determined via a (known or estimated) size of the object 8.

In FIG. 3, it is also possible for the angles 3, 4 and optionally in addition the height 5 to be determined as extrinsic camera parameters from a selection of two step distances 12b with double steps of one foot 9 or 10 and two step distances 12b with double steps of the other foot 10 or 9. It is also possible for the extrinsic camera parameters to be determined from three step distances 12b with double steps of one foot 9 or 10 and a step distance 12b with a double step of the other foot 10 or 9. The step distances 12b may be arranged contiguously or spaced apart in the trajectory 13.

1. A computer-implemented method for determining extrinsic camera parameters of a camera (1), the method comprising:
capturing image data from a camera,
determining, via a computer, foot strike points (11 a, b) of at least one object (8) walking on a monitoring base area (2) based on image data of the camera (1),
wherein the foot strike points (11 a, b) form at least three step sections (12 a, b), wherein each step section (12 a, b) is defined by two foot strike points (11 a, b), and
wherein the step sections (12 a, b) each have a section length on the monitoring base area (2), and
determining, via the computer, a pitch angle (3) and/or a roll angle (4) of the camera (1) relative to the monitoring base area (2) based on the location of the step sections (12 a, b) as well as a ratio of the section lengths on the monitoring base area (2) and/or based on the absolute section lengths on the monitoring base area (2).

2. A method according to claim 1, wherein the at least three step sections (12 a, b) each define a straight line section on the monitoring base area (2), wherein the straight line sections intersect.

3. A method according to claim 1, wherein the three step sections (12 a, b) comprise at least one common foot strike point (11 a, b) and/or are associated with a common object (8).

4. A method according to claim 1, wherein the step sections (12 a, b) are not connected and/or are associated with different objects (8) and/or different trajectories (13) of the same object (8) and/or spaced trajectory sections of the trajectory (13) of the same object (8).

5. A method according to claim 1, wherein the step sections (12 a, b) each form a step of the object (8) or a double step of the object (8).

6. A method according to claim 1, wherein a height (5) of the camera (1) relative to the monitoring base area (2) is determined based on at least a section length of one of the step sections (12 a, b).

7. A method according to claim 1, wherein the absolute section length is estimated as a function of the time needed to traverse the step section (12 a, b).

8. A method according to claim 1, wherein the foot strike points (11 a, b) are determined by digital image processing via the analysis of the optical flow in the image data.

9. An evaluation module (7) for determining extrinsic camera parameters of a camera (1)
having an interface for connection to a data source via data technology for receiving image data, wherein the evaluation module (7) is configured to
determine foot strike points (11 a, b) of at least one object (8) walking on a monitoring base area (2) based on the image data,
wherein the foot strike points (11 a, b) form at least three step sections (12 a, b), wherein each step section (12 a, b) is defined by two foot strike points (11 a, b), and
wherein the step sections (12 a, b) each have a section length on the monitoring base area (2), and
determine a pitch angle (3) and/or a roll angle (4) of a camera (1) relative to the monitoring base area (2) based on the location of the step sections (12 a, b) as well as a ratio of the section lengths on the monitoring base area (2) and/or on the based on the absolute section lengths on the monitoring base area (2).

10. A camera (1) comprising the evaluation module (7) according to claim 9.

11. A non-transitory, computer-readable medium containing instructions that when executed by a computer cause the computer to
determine foot strike points (11 a, b) of at least one object (8) walking on a monitoring base area (2) based on image data,
wherein the foot strike points (11 a, b) form at least three step sections (12 a, b), wherein each step section (12 a, b) is defined by two foot strike points (11 a, b), and
wherein the step sections (12 a, b) each have a section length on the monitoring base area (2), and
determine a pitch angle (3) and/or a roll angle (4) of a camera (1) relative to the monitoring base area (2) based on the location of the step sections (12 a, b) as well as a ratio of the section lengths on the monitoring base area (2) and/or based on the absolute section lengths on the monitoring base area (2).
